(19) United States
(12) Patent Application Publication
(10) Pub. No.: US 2020/0201619 A1
(43) Pub. Date: Jun. 25, 2020

(54) METHOD FOR CONTROLLING DISPLAY DEVICE, DISPLAY DEVICE, AND DISPLAY SYSTEM

(71) Applicant: SEIKO EPSON CORPORATION, Tokyo (JP)

(72) Inventor: Makoto SHIGEMITSU, Sapporo-shi (JP)

(73) Assignee: SEIKO EPSON CORPORATION, Tokyo (JP)

(21) Appl. No.: 16/718,341

(22) Filed: Dec. 18, 2019

(30) Foreign Application Priority Data
Dec. 19, 2018 (JP) 2018-237012

(51) Int. Cl. G06F 8/65; H04W 4/80; G06F 3/14

(52) U.S. Cl. CPC G06F 8/65; G06F 3/1407; H04W 4/80

(57) ABSTRACT

A method for controlling a display device storing software includes: providing a first instruction to a first communication terminal in a status where communication with the first communication terminal is established, the first instruction instructing the first communication terminal to acquire an update notification prompting update of the software; and displaying, on a display surface, an update notification image based on an update notification acquired by the first communication terminal in response to the first instruction, when receiving the update notification from the first communication terminal.

The present application is based on, and claims priority from JP Application Serial Number 2018-237012, filed Dec. 19, 2018, the disclosure of which is hereby incorporated by reference herein in its entirety.

### BACKGROUND

### 1. Technical Field

The present disclosure relates to a method for controlling a display device, a display device, and a display system.

### 2. Related Art

JP-A-2014-115717 describes a technique in which a communication terminal that can wirelessly communicate with a device having a display function transmits, to a server, an inquiry about update of software installed in the device having the display function, and receives a response to that inquiry. This communication terminal transmits the inquiry to the server regardless of whether wireless communication with the device having the display function is established or not.

In the technique described in JP-A-2014-115717, when the communication terminal receives a response from the server in a status where the device having the display function cannot communicate with the communication terminal, the device having the display function cannot receive the response from the communication terminal. Therefore, the response received by the communication terminal from the server may become useless.

### SUMMARY

An aspect of the present disclosure is directed to a method for controlling a display device storing software including: providing a first instruction to a first communication terminal in a status where communication with the first communication terminal is established, the first instruction instructing the first communication terminal to acquire an update notification prompting update of the software; and displaying, on a display surface, an update notification image based on an update notification acquired by the first communication terminal in response to the first instruction, when receiving the update notification from the first communication terminal.

Another aspect of the present disclosure is directed to a display device storing software including: a first instruction unit providing a first instruction to a first communication terminal in a status where communication with the first communication terminal is established, the first instruction instructing the first communication terminal to acquire an update notification prompting update of the software; a display unit; and a display control unit causing the display unit to display, on a display surface, an update notification image based on an update notification acquired by the first communication terminal in response to the first instruction, when receiving the update notification from the first communication terminal.

Still another aspect of the present disclosure is directed to a display system including: a display device storing software; and a first communication terminal. The display device includes: a first instruction unit providing a first instruction to the first communication terminal in a status where communication with the first communication terminal is established, the first instruction instructing the first communication terminal to acquire an update notification prompting update of the software; a display unit; and a display control unit causing the display unit to display, on a display surface, an update notification image based on an update notification acquired by the first communication terminal in response to the first instruction, when receiving the update notification from the first communication terminal. The first communication terminal includes: an update notification acquisition unit acquiring the update notification from a server managing update of the software, when receiving the first instruction; and a providing unit providing the update notification to the display device.

### BRIEF DESCRIPTION OF THE DRAWINGS

FIG. 1 shows an example of a display system A according to a first embodiment.

FIG. 2 shows an example of a projector 1.

FIG. 3 shows an example of a first communication terminal 2.

FIG. 4 shows an example of a projection unit 12.

FIG. 5 is a sequence chart for explaining an operation of the display system A.

FIG. 6 shows an example of update data D.

FIG. 7 shows an example of a projector 1 according to modification example 2.

### DESCRIPTION OF EXEMPLARY EMBODIMENTS

### A: First Embodiment

### A1: Outline of Display System A

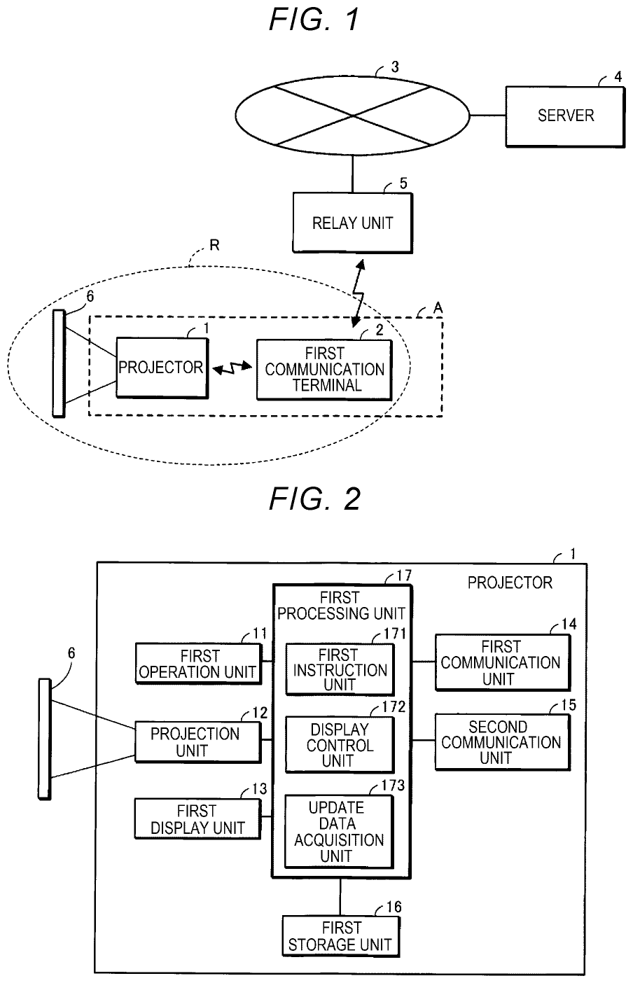

FIG. 1 shows an example of a display system A according to a first embodiment. The display system A includes a projector 1 and a first communication terminal 2. The projector 1 and the first communication terminal 2 can communicate with each other via short-range wireless communication. Specifically, when the first communication terminal 2 is located within a communication range R of the projector 1, the projector 1 and the first communication terminal 2 can communicate with each other. The first communication terminal 2 connects to a communication network 3 including the internet or the like via a relay unit 5 which is an access point of a wireless LAN (local area network). The first communication terminal 2 communicates with a server 4 via the relay unit 5 and the communication network 3. The relay unit 5 is not limited to the access point of the wireless LAN and can be changed according to need. For example, when the first communication terminal 2 communicates with the server 4 via a mobile phone network, a wireless base station is used as the relay unit 5.

The projector 1 projects various images onto a projection surface 6. The projection surface 6 is an example of a display surface. The projector 1 is an example of a display device. Software is installed in the projector 1. In other words, the projector 1 stores software. Hereinafter, the software installed in the projector 1 is referred to as “first software”. The first software is, for example, firmware. However, the first software is not limited to the firmware and may be, for example, an operating system or application program. The projector 1 executes the first software and thus performs various operations.

The first communication terminal 2 is a mobile communication terminal such as a smartphone or tablet terminal. The first communication terminal 2 is carried by a user. In the first communication terminal 2, an application program for communicating with each of the projector 1 and the server 4 is installed. Hereinafter, the application program for communicating with each of the projector 1 and the server 4 is referred to as a “first app”. The first communication terminal 2 executes the first app and thus communicates, for example, with each of the projector 1 and the server 4.

The server 4 stores update data of the first software. The server 4 stores the update data of the first software in association with version information representing the version of the first software. Specifically, the server 4 stores the update data of the first software for every version of the first software.

### A2: Example of Projector 1

FIG. 2 shows an example of the projector 1. The projector 1 includes a first operation unit 11, a projection unit 12, a first display unit 13, a first communication unit 14, a second communication unit 15, a first storage unit 16, and a first processing unit 17.

The first operation unit 11 is, for example, various operation buttons or operation keys, or a touch panel. The first operation unit 11 receives an input operation by the user. The first operation unit 11 may be a remote controller or the like transmitting information corresponding to the input operation by the user, wirelessly or via a wire. In this case, the projector 1 has a receiving unit receiving the information transmitted from the remote controller. The remote controller has various operation buttons or operation keys or a touch panel receiving the input operation by the user.

The projection unit 12 projects an image of various kinds onto the projection surface 6 and thus displays the image on the projection surface 6. The image projected by the projection unit 12 is, for example, an image based on a notification received by the projector 1 from the first communication terminal 2 and an image based on image information supplied from an image supply device, not illustrated. The image supply device is, for example, a PC (personal computer). However, the image supply device is not limited to the PC and may be, for example, a DVD (digital versatile disc) player.

The first display unit 13 is a liquid crystal display panel. However, the first display unit 13 is not limited to the liquid crystal display panel and may be, for example, an organic EL display panel. The first display unit 13 displays various images on a display screen of the first display unit 13. The first display unit 13 is an example of the display unit. The display screen is another example of the display surface.

The first communication unit 14 establishes communication with the first communication terminal 2. Specifically, the first communication unit 14 wirelessly communicates directly with the first communication terminal via short-range wireless communication. The first communication unit 14 may also establish communication with the first communication terminal 2 via a wire. The first communication unit 14 uses Bluetooth communication, more specifically BLE (Bluetooth Low Energy) communication, as the short-range wireless communication. Bluetooth is a registered trademark. The short-range wireless communication is not limited to Bluetooth communication, more specifically BLE communication, and may be, for example, infrared communication, visible light communication, or NFC (near-field communication) or the like.

The second communication unit 15 wirelessly communicates directly with the first communication terminal or the image supply device via short-range wireless communication that is different from the short-range wireless communication used by the first communication unit 14. The second communication unit 15 uses Wi-Fi Direct communication as the short-range wireless communication. Wi-Fi Direct is a registered trademark. Wi-Fi (Wireless Fidelity) is a registered trademark.

The first storage unit 16 includes, for example, a flash memory, a ROM (read-only memory), and a RAM (random-access memory). The first storage unit 16 is an example of a computer-readable recording medium. The first storage unit 16 stores various kinds of information and a program prescribing the operation of the first processing unit 17. The program prescribing the operation of the first processing unit 17 includes the first software.

The first processing unit 17 is a computer such as a CPU (central processing unit). The first processing unit 17 may be formed of one or a plurality of processing devices. The first processing unit 17 reads and executes the program stored in the first storage unit 16 and thus implements a first instruction unit 171, a display control unit 172, and an update data acquisition unit 173.

The first instruction unit 171 provides the first communication terminal 2 with a first instruction instructing the first communication terminal 2 to acquire an update notification for the first software, using the first communication unit 14, in a status where BLE communication between the projector 1 and the first communication terminal 2 is established.

The update notification is a notification prompting update of the first software. For example, when the version of the first software installed in the projector 1 is older than the latest version of the first software stored in the server 4, a notification that the first software can be updated is used as the update notification. The update notification is acquired by the first communication terminal 2 from the server 4.

When the first communication unit 14 receives the update notification from the first communication terminal 2, the display control unit 172 causes the projection unit 12 to project an update notification image based on the update notification, onto the projection surface 6. The update notification is, for example, information representing the update notification image.

The update notification image is, for example, an image showing the letters “You can update the first software. Update?” However, the update notification image is not limited to the foregoing image and can be changed according to need. When the first communication unit 14 receives the update notification from the first communication terminal 2, the display control unit 172 may cause the first display unit 13 to display the update notification image.

The update data acquisition unit 173 acquires the update data of the first software. In this embodiment, the update data acquisition unit 173 establishes Wi-Fi Direct communication with the first communication terminal 2, using the second communication unit 15, and acquires the update data of the first software via Wi-Fi Direct communication.

### A3: Example of First Communication Terminal 2

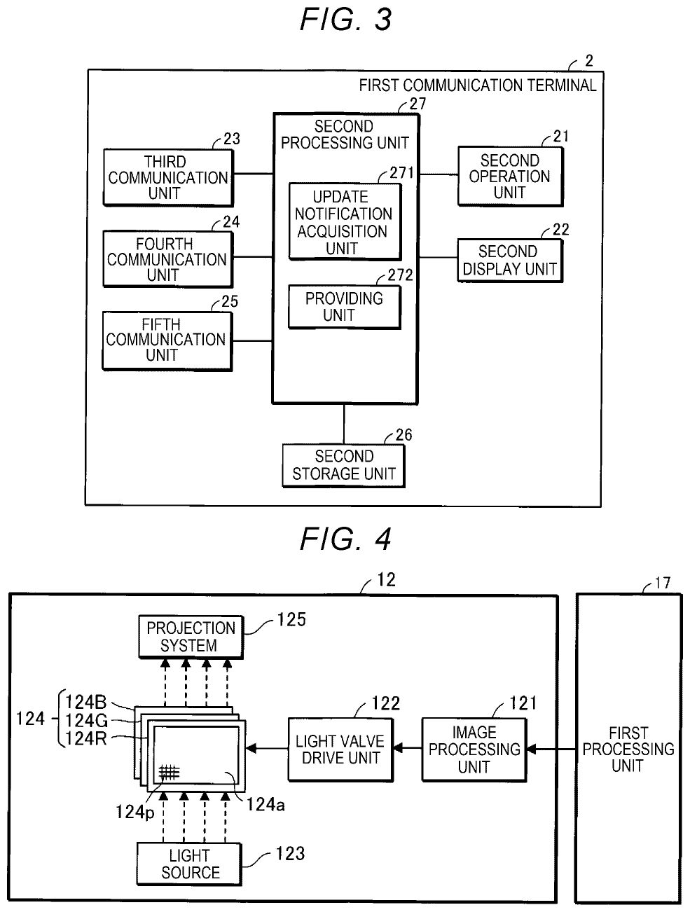

FIG. 3 shows an example of the first communication terminal 2. The first communication terminal 2 includes a second operation unit 21, a second display unit 22, a third communication unit 23, a fourth communication unit 24, a fifth communication unit 25, a second storage unit 26, and a second processing unit 27.

The second operation unit 21 is, for example, various operation buttons or operation keys, or a touch panel. The second operation unit 21 receives an input operation by a user.

The second display unit 22 is a liquid crystal display panel. However, the second display unit 22 is not limited to the liquid crystal display panel and may be, for example, an organic EL display panel.

The third communication unit 23 executes communication of the same type as the communication used by the first communication unit 14 of the projector 1. In this embodiment, the third communication unit 23 executes BLE communication, similarly to the first communication unit 14.

The fourth communication unit 24 communicates, for example, with the server 4 via the relay unit 5, using wireless LAN communication such as Wi-Fi communication.

The fifth communication unit 25 executes communication of the same type as the communication used by the second communication unit 15 of the projector 1. In this embodiment, the fifth communication unit 25 executes Wi-Fi Direct communication, similarly to the second communication unit 15.

The second storage unit 26 includes, for example, a flash memory, a ROM, and a RAM. The second storage unit 26 is an example of a computer-readable recording medium. The second storage unit 26 stores various kinds of information and a program prescribing the operation of the second processing unit 27. The program prescribing the operation of the second processing unit 27 includes the first app.

The second processing unit 27 is, for example, a computer such as a CPU. The second processing unit 27 may be formed of one or a plurality of processing devices. The second processing unit 27 reads and executes the program stored in the second storage unit 26 and thus implements an update notification acquisition unit 271 and a providing unit 272.

When receiving the first instruction from the projector 1 via BLE communication, the update notification acquisition unit 271 acquires the update notification for the first software from the server 4 via the fourth communication unit 24.

The providing unit 272 transmits the update notification for the first software acquired by the update notification acquisition unit 271, to the projector 1 via BLE communication.

The providing unit 272 also requests the update data of the first software from the server 4 and receives the update data of the first software from the server 4. The providing unit 272 transmits the update data of the first software to the projector 1.

### A4: Example of Projection Unit 12

FIG. 4 shows an example of the projection unit 12 of the projector 1. The projection unit 12 includes an image processing unit 121, a light valve drive unit 122, a light source 123, a liquid crystal light valve for red 124R, a liquid crystal light valve for green 124G, a liquid crystal light valve for blue 124B, and a projection system 125. Hereinafter, when the liquid crystal light valve for red 124R, the liquid crystal light valve for green 124G, and the liquid crystal light valve for blue 124B need not be discriminated from each other, these are referred to as the “liquid crystal light valve 124”.

The image processing unit 121 is, for example, a computer such as a CPU. The image processing unit 121 may be formed of one or a plurality of processing devices. The image processing unit 121 generates, for example, image information based on the update notification for the first software, using the update notification for the first software. The image processing unit 121 performs image processing of the image information and thus generates an image signal.

The image processing executed by the image processing unit 121 includes, for example, resolution conversion processing. In the resolution conversion processing, the image processing unit 121 converts the resolution of the image information, for example, into the resolution of the liquid crystal light valve 124. The image processing unit 121 may execute other image processing, for example, gamma correction processing, in addition to or instead of the resolution conversion processing.

The light valve drive unit 122 drives the liquid crystal light valve 124, based on the image signal inputted from the image processing unit 121.

The light source 123 is, for example, an LED (light-emitting diode). However, the light source 123 is not limited to the LED and may be, for example, a xenon lamp, ultra-high-pressure mercury lamp, or laser light source or the like. The light emitted from the light source 123 is reduced in unevenness in the luminance distribution by an optical integration system, not illustrated, and is subsequently separated into color light components of red, green, and blue, which are the primary colors of light, by a color separation system, not illustrated. The red color light component becomes incident on the liquid crystal light valve for red 124R. The green color light component becomes incident on the liquid crystal light valve for green 124G. The blue color light component becomes incident on the liquid crystal light valve for blue 124B.

The liquid crystal light valve 124 is formed of a liquid crystal panel or the like having a pair of transparent substrates with a liquid crystal arranged between them. The liquid crystal light valve 124 has a rectangular pixel area 124a including a plurality of pixels 124p located into a matrix. In the liquid crystal light valve 124, a drive voltage is applied to the liquid crystal at each pixel 124p. When the light valve drive unit 122 applies a drive voltage based on the image signal to each pixel 124p, each pixel 124p is set to a light transmittance based on the drive voltage. The light emitted from the light source 123 is modulated by passing through the pixel area 124a and thus forms an image based on the image signal, corresponding to each color light. The liquid crystal light valve 124 is an example of a light modulation device.

The images of the respective colors are combined together at each pixel 124p by a light combining system, not illustrated, and thus form a color image. The color image is projected onto the projection surface 6 by the projection system 125.

### A5: Explanation of Operation

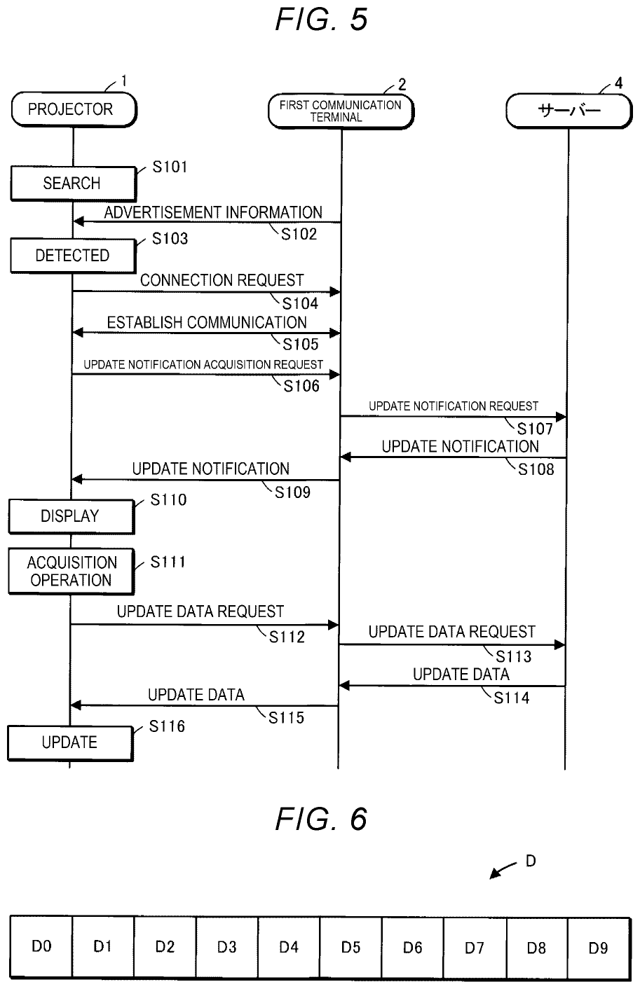

FIG. 5 is a sequence chart for explaining an operation of the display system A. The operation shown in FIG. 5 is executed periodically, for example, every ten minutes, in the status where the projector 1 is in a stand-alone state of not being connected to the communication network 3, more specifically, the server 4. The time interval at which the operation shown in FIG. 5 is executed is not limited to ten minutes and can be changed according to need. The operation shown in FIG. 5 may be executed, for example, in response to an instruction from the user.

In step S101, the first instruction unit 171 of the projector 1 searches for a communication terminal in which the first app is already installed, for example, the first communication terminal 2, using the first communication unit 14. Specifically, in step S101, the first instruction unit 171 causes the first communication unit 14 to receive the advertisement information wirelessly transmitted by the first communication terminal 2 from the third communication unit 23.

In this status, when the user carrying the first communication terminal 2 is not located within the communication range R for BLE communication of the projector 1, the first instruction unit 171 ends step S101. Meanwhile, when the user carrying the first communication terminal 2 is located within the communication range R for BLE communication of the projector 1, the advertisement information wirelessly transmitted from the first communication terminal 2 reaches the projector 1 in step S102. As the first communication unit 14 receives the advertisement information transmitted by the first communication terminal 2, the first instruction unit 171 in step S103 determines that the first communication terminal 2 is detected.

When the first communication terminal 2 is detected, the first instruction unit 171 in step S104 performs connection processing for BLE communication with the first communication terminal 2 and subsequently transmits a connection request from the first communication unit 14 to the first communication terminal 2. By transmitting the connection request, the first instruction unit 171 in step S105 establishes communication, specifically BLE communication, between the projector 1 and the first communication terminal 2. The operation of steps S101 to S105 is a general operation based on BLE communication.

When BLE communication between the projector 1 and the first communication terminal 2 is established, the first instruction unit 171 in step S106 transmits an update notification acquisition request from the first communication unit 14 to the first communication terminal 2 in response to the establishment of BLE communication. The update notification acquisition request includes the version information of the first software installed in the projector 1.

When the third communication unit 23 of the first communication terminal 2 receives the update notification acquisition request, the update notification acquisition unit 271 in step S107 transmits an update notification request from the fourth communication unit 24 to the server 4. The update notification request includes the version information of the first software included in the update notification acquisition request.

On receiving the update notification request, the server 4 determines whether or not the version information of the first software included in the update notification request is older than the latest version information of the first software managed by the server 4.

When the version information of the first software included in the update notification request is older than the latest version information of the first software managed by the server 4, the sever 4 transmits an update notification to the first communication terminal 2 in step S108.

Subsequently, when the fourth communication unit 24 of the first communication terminal 2 receives the update notification, the providing unit 272 transmits the update notification from the third communication unit 23 to the projector 1 in step S109. That is, the update notification is transmitted from the first communication terminal 2 to the projector 1 via BLE communication.

When the first communication unit 14 of the projector 1 receives the update notification, the display control unit 172 in step S110 causes the projection unit 12 to project an update notification image based on the update notification onto the projection surface 6. The display control unit 172 may cause the first display unit 13 to display the update notification image, instead of causing the projection unit 12 to project the update notification image. For example, when the projection unit 12 is not in operation, the display control unit 172 causes the first display unit 13 to display the update notification image. Alternatively, the display control unit 172 may cause the projection unit 12 to project the update notification image and also cause the first display unit 13 to display the update notification image.

The user views the update notification image and thus recognizes that the first software needs updating. Then, the user carries out an acquisition operation to acquire update data of the first software, using the first operation unit 11 of the projector 1.

Subsequently, when the first operation unit 11 receives the acquisition operation in step S111, the update data acquisition unit 173 establishes Wi-Fi Direct communication between the second communication unit 15 and the fifth communication unit 25 of the first communication terminal 2.

For example, the update data acquisition unit 173 first causes the projection unit 12 or the first display unit 13 to display a connection image prompting the projector 1 to be connected to the first communication terminal 2 via Wi-Fi Direct communication.

Subsequently, when the user carries out a connection operation to connect the projector 1 to the first communication terminal 2 via Wi-Fi Direct communication using the first operation unit 11 according to the connection image, the first operation unit 11 receives the connection operation.

As the first operation unit 11 receives the connection operation, the update data acquisition unit 173 executes processing for establishing Wi-Fi Direct communication between the second communication unit 15 and the fifth communication unit 25 and thus establishes the Wi-Fi Direct communication between the second communication unit 15 and the fifth communication unit 25.

When the Wi-Fi Direct communication between the second communication unit 15 and the fifth communication unit is established, the update data acquisition unit 173 transmits an update data request for the first software from the second communication unit 15 to the first communication terminal 2 in step S112. That is, the update data request for the first software is transmitted from the projector 1 to the first communication terminal 2 via Wi-Fi Direct communication. The update data request for the first software includes the version information of the first software installed in the projector 1.

When the fifth communication unit 25 of the first communication terminal 2 receives the update data request for the first software, the providing unit 272 transmits the update data request for the first software from the fourth communication unit 24 to the server 4 in step S113.

On receiving the update data request for the first software, the server 4 in step S114 transmits, to the first communication terminal 2, update data corresponding to newer version information than the version information included in the update data request for the first software, of the update data of the first software managed by the server 4.

When the fourth communication unit 24 of the first communication terminal 2 receives the update data, the providing unit 272 transmits the update data from the fifth communication unit 25 to the projector 1 in step S115. That it, the update data is transmitted from the first communication terminal 2 to the projector 1 via Wi-Fi Direct communication.

When the second communication unit 15 of the projector 1 receives the update data, the update data acquisition unit 173 executes update of the first software using the update data in step S116.

When the version information of the first software included in the update notification request transmitted in step S107 is not older than the latest version information of the first software managed by the server 4, that is, when the version information of the first software included in the update notification request is the latest version information, the server 4 transmits a no-need-for-update notification showing that no update is needed, to the first communication terminal 2. In this case, the first communication terminal 2 ends the operation shown in FIG. 5, transmitting neither the no-need-for-update notification nor the update notification to the projector 1.

In the projector 1 and the method for controlling the projector 1 according to this embodiment, the first instruction unit 171 provides a first instruction to the first communication terminal 2 in the status where communication with the first communication terminal 2 is established. When the display control unit 172 receives, from the first communication terminal 2, an update notification acquired by the first communication terminal 2 in response to the first instruction, the display control unit 172 causes the projection unit 12 to display an update notification image onto the projection surface 6.

Since the first instruction is provided to the first communication terminal 2 in the status where communication with the first communication terminal 2 is established, as described above, it is highly likely that the communication between the projector 1 and the first communication terminal 2 is already established at the time point when the update notification acquired by the first communication terminal 2 in response to the first instruction is transmitted. Therefore, the update notification acquired by the first communication terminal 2 in response to the first instruction can be restrained from failing to reach the projector 1 and becoming useless.

Also, since the first instruction unit 171 provides the first instruction to the first communication terminal 2 in the status where communication with the first communication terminal 2 is established, the first instruction transmitted from the projector 1 can be restrained from failing to reach the first communication terminal 2 and becoming useless.

Thus, in this embodiment, the projector 1 can receive the update notification even when not connected directly to the communication network 3 including the internet.

In this embodiment, the first instruction unit 171 provides the first instruction to the first communication terminal 2 in response to the establishment of communication with the first communication terminal 2, that is, triggered by the establishment of communication with the first communication terminal 2. Therefore, the first instruction can be provided to the first communication terminal 2 at a timing when the first instruction can be provided to the first communication terminal 2.

In this embodiment, the update data acquisition unit 173 acquires update data for updating software via the first communication terminal 2 in response to the reception of the update notification from the first communication terminal 2, that is, triggered by the reception of the update notification from the first communication terminal 2. Therefore, the update data can be acquired when update is needed.

### B: Modification Examples

In the first embodiment, for example, the following configurations may be employed.

### B1: Modification Example 1

In the first embodiment, the update data acquisition unit 173 acquires the update data, using Wi-Fi Direct communication with a higher communication speed than BLE communication. However, the update data may be acquired via BLE communication.

BLE communication has a measured communication speed of approximately 10 KB/s. Therefore, for example, when the size of the update data is 100 MB, it takes approximately 27 hours for the update data acquisition unit 173 to acquire the update data. It is unlikely that the user carrying the first communication terminal 2 continues being located within the communication range R for BLE communication of the projector 1 for such a long period.

Thus, in the case where BLE communication with the first communication terminal 2 is disconnected during the acquisition of the update data and where BLE communication with a second communication terminal is established after the disconnection of the previous BLE communication, the update data acquisition unit 173 acquires the part that cannot be acquired via the first communication terminal 2, of the update data, via the second communication terminal in the status where BLE communication with the second communication terminal is established. The second communication terminal may be a communication terminal that is different from the first communication terminal 2 or may be the first communication terminal 2.

An example of modification example 1 will now be described. In modification example 1, it is assumed that update data D of 100 MB is split into ten blocks D0 to D9, as shown in FIG. 6. The data volume of the update data D is not limited to 100 MB and may be greater or smaller than 100 MB. The number of blocks of the update data D is not limited to ten and may be any number equal to or greater than two. The data volume of each block is not limited to 10 MB and may be greater or smaller than 10 MB. The data volumes of the respective blocks may not be the same as each other.

It is now assumed that, in this circumstance, when the first communication terminal 2 finishes transmitting the 20-MB data of the blocks D0 and D1 to the projector 1 via BLE communication, a user A1 carrying the first communication terminal 2 moves to another spot from the communication range R of BLE communication of the projector 1.

Subsequently, a user A2 carrying the second communication terminal of the same configuration as the first communication terminal 2 enters the communication range R of BLE communication of the projector 1 and establishes BLE communication between the projector 1 and the second communication terminal. Then, the update data acquisition unit 173 transmits a request for the update data D of the block D2 onward, to the second communication terminal via BLE communication.

On receiving the request for the update data D of the block D2 onward, the providing unit of the second communication terminal acquires the update data D of the block D2 onward from the server 4 and transmits the update data D of the block D2 onward to the projector 1 via BLE communication.

Subsequently, it is assumed that, when the second communication terminal finishes transmitting the 60-MB update data D of the blocks D2 to D7 to the projector 1 via BLE communication, the user A2 carrying the second communication terminal moves to another spot from the communication range R for BLE communication of the projector 1.

Subsequently, the user A1 carrying the first communication terminal 2 reenters the communication range R for BLE communication of the projector 1 and establishes BLE communication between the projector 1 and the first communication terminal 2. Then, the update data acquisition unit 173 transmits a request for the update data D of the block D8 onward to the first communication terminal 2 via BLE communication.

On receiving the request for the update data D of the block D8 onward, the providing unit 272 of the first communication terminal 2 acquires the update data D of the block D8 onward from the server 4 and transmits the update data D of the block D8 onward to the projector 1 via BLE communication.

According to modification example 1, the update data D can be received block by block. Therefore, the first communication terminal 2 need not continue being located within the communication range R for BLE communication of the projector 1 until receiving the entirety of the update data D.

As described in the first embodiment, when the projector 1 acquires the update data D via Wi-Fi Direct communication, the user needs to carry out a change operation to change the connection destination of Wi-Fi Direct communication. Meanwhile, when the projector 1 acquires the update data D via BLE communication as in modification example 1, such a change operation is not needed.

As described in the first embodiment, while the projector 1 is acquiring the update data D from the first communication terminal 2 via Wi-Fi Direct communication, the projector 1 cannot perform Wi-Fi Direct communication with a device that is different from the first communication terminal 2, for example, a PC supplying image information. Meanwhile, when acquiring the update data D via BLE communication as in modification example 1, the projector 1 can perform Wi-Fi Direct communication with the PC supplying image information, while acquiring the update data D from the first communication terminal 2 via BLE communication.

### B2: Modification Example 2

In the first embodiment and modification example 1, the projector 1 may decide a communication method used to acquire the update data of the first software, based on the data volume of the update data of the first software.

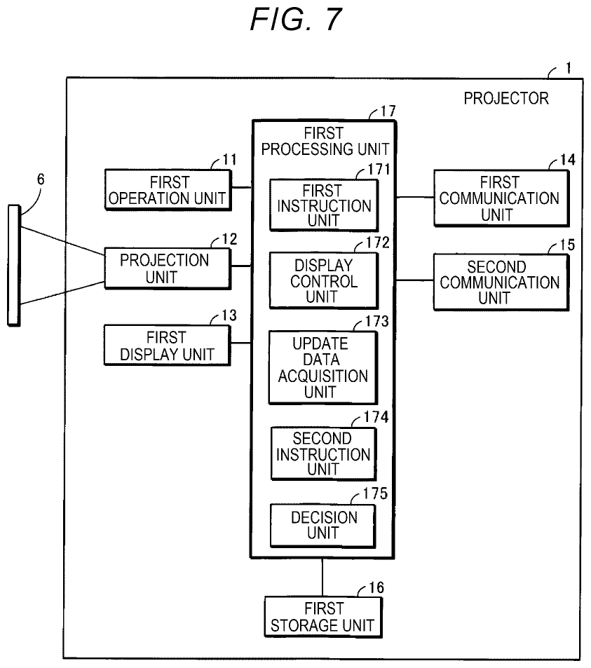

FIG. 7 shows an example of a projector 1 according to modification example 2. The projector 1 according to modification example 2 differs from the first embodiment in that it has a second instruction unit 174 and a decision unit 175. The projector 1 according to modification example 2 will now be described mainly in terms of the difference from the first embodiment.

The second instruction unit 174 provides the first communication terminal 2 with a second instruction instructing the first communication terminal 2 to acquire the data volume of the update data of the first software, via BLE communication, in response to the reception of the update notification from the first communication terminal 2, specifically, triggered by the reception of the update notification from the first communication terminal 2.

When the third communication unit 23 receives the second instruction, the providing unit 272 of the first communication terminal 2 sends an inquiry about the data volume of the update data of the first software, to the server 4.

On receiving the inquiry about the data volume, the server 4 transmits the data volume of the update data of the first software to the first communication terminal 2.

When the fourth communication unit 24 receives the data volume of the update data of the first software, the providing unit 272 of the first communication terminal 2 transmits the data volume of the update data of the first software to the projector 1 via BLE communication.

When the first communication unit 14 receives the data volume of the update data of the first software, the decision unit 175 decides a communication method used to acquire the update data of the first software, based on this data volume. The communication method is also referred to as a communication system or communication mode. For example, the decision unit 175 decides whether or not to acquire the update data of the first software, using short-range wireless communication such as BLE communication, based on the data volume of the update data of the first software. The short-range wireless communication includes BLE communication but does not include Wi-Fi Direct communication.

In modification example 2, when the data volume of the update data of the first software is equal to or greater than a threshold, the decision unit 175 decides to use Wi-Fi Direct communication as the communication method used to acquire the update data.

Meanwhile, when the data volume of the update data is less than the threshold, the decision unit 175 decides to use BLE communication as the communication method used to acquire the update data.

When the decision unit 175 decides to use Wi-Fi Direct communication as the communication method used to acquire the update data, the update data acquisition unit 173 acquires the update data of the first software, using Wi-Fi Direct communication, as described in the first embodiment.

Meanwhile, when the decision unit 175 decides to use BLE communication as the communication method used to acquire the update data, the update data acquisition unit 173 acquires the update data of the first software, using BLE communication, as described in modification example 1.

According to modification example 2, when the data volume of the update data is equal to or greater than the threshold, the update data is acquired via Wi-Fi Direct communication with a higher communication speed than BLE communication. Therefore, the update data can be acquired in a shorter time than in the case of acquiring the update data via BLE communication.

Meanwhile, when the data volume of the update data is less than the threshold, the update data is acquired via BLE communication, which needs no change operation to change the communication destination. Therefore, the update data can be acquired more easily than in the case of acquiring the update data via Wi-Fi Direct communication.

When the communication speed of a first communication method used in the case where the data volume of the update data is equal to or greater than the threshold is higher than the communication speed of a second communication method used in the case where the data volume of the update data is less than the threshold, the first communication method is not limited to Wi-Fi Direct communication, and the second communication method is not limited to BLE communication.

### B3: Modification Example 3

In one of the first embodiment and modification examples 1 and 2, the display control unit 172 may cause the projection unit 12 to project, onto the projection surface 6, an image showing that the update data is being acquired, or may cause the first display unit 13 to display an image showing that the update data is being acquired.

The image showing that the update data is being acquired is, for example, an image showing the letters “Acquiring update data”. However, the image showing that the update data is being acquired is not limited to the foregoing image and can be changed according to need.

According to modification example 3, the user can be informed that the update data is being acquired.

### B4: Modification Example 4

In one of the first embodiment and modification examples 1 to 3, on receiving information that is different from the update notification from the first communication terminal 2, the display control unit 172 may cause the projection unit 12 to project, onto the projection surface 6, an image based on the information that is different from the update notification, or may cause the first display unit 13 to display an image based on the information that is different from the update notification.

For example, when the server 4 transmits the update notification and additional information to the first communication terminal 2 in response to the update notification request and the first communication terminal 2 transmits the update notification and the additional information received from the server 4 to the projector 1, the display control unit 172 causes the projection unit 12 to project an image based on the additional information onto the projection surface 6 and causes the first display unit 13 to display an image based on the additional information.

The additional information is, for example, information of an advertisement of a commodity. However, the additional information is not limited to the information of an advertisement of a commodity and may be, for example, information of an event using a projector.

The server 4 may transmit the additional information instead of the no-need-for-update notification. In this case, the first communication terminal 2 transmits the additional information received from the server 4, to the projector 1. The display control unit 172 of the projector 1 causes the projection unit 12 to project an image based on the additional information onto the projection surface 6 and causes the first display unit 13 to display an image based on the additional information.

According to modification example 4, using information that is different from the update notification transmitted from the server 4, the projector 1 can display an image based on this information.

### B5: Modification Example 5

In one of the first embodiment and modification examples 1 to 4, the fourth communication unit 24 may communicate with the communication network 3, more specifically, the server 4, via a wireless base station of a mobile phone network.

In this case, when the first communication terminal 2 communicates with the server 4, the first communication terminal 2 is charged for the communication. Therefore, for example, an inquiry about whether to consent to communicating with the server 4 or not may be sent to the user of the first communication terminal 2, and only the first communication terminal 2 to which a response to consent is inputted, more specifically, the update notification acquisition unit 271 and the providing unit 272 of the first communication terminal 2 to which a response to consent is inputted, may communicate with the server 4, using the fourth communication unit 24. Taking such a measure can restrain excessive charging of communication fees onto the user of the first communication terminal 2.

### B6: Modification Example 6

In one of the first embodiment and modification examples 1 to 5, the liquid crystal light valve 124 is used as an example of the light modulation device. However, the light modulation device is not limited to the liquid crystal light valve and can be changed according to need. For example, the light modulation device may have a configuration using three reflection-type liquid crystal panels. The light modulation device may also have such a configuration as a system using one liquid crystal panel, a system using three digital mirror devices (DMDs), or a system using one digital mirror device. When only one liquid crystal panel or DMD is used as the light modulation device, components equivalent to the color separation system and the light combining system are not needed. Other than the liquid crystal panel and the DMD, any configuration that can modulate the light emitted from the light source 123 can be employed as the light modulation device.

### B7: Modification Example 7

In one of the first embodiment and modification examples 1 to 6, the first display unit 13 may be omitted.

### B8: Modification Example 8

In one of the first embodiment and modification examples 1 to 7, each element implemented by each of the first processing unit 17 and the second processing unit 27 executing a program may be implemented by hardware including an electronic circuit, for example, an FPGA (field-programmable gate array) or ASIC (application-specific IC). The image processing unit 121 may be implemented, for example, by an electronic circuit such as an FPGA or ASIC.

### B9: Modification Example 9

In one of the first embodiment and modification examples 1 to 8, the projector 1 is used as the display device. However, the display device may be a direct-view display device such as a liquid crystal display device or EL display device.

What is claimed is:

1. A method for controlling a display device storing software, the method comprising:
providing a first instruction to a first communication terminal in a status where communication with the first communication terminal is established, the first instruction instructing the first communication terminal to acquire an update notification prompting update of the software; and
displaying, on a display surface, an update notification image based on an update notification acquired by the first communication terminal in response to the first instruction, when receiving the update notification from the first communication terminal.

2. The method for controlling the display device according to claim 1, wherein
the first instruction is provided to the first communication terminal in response to the establishing of communication with the first communication terminal.

3. The method for controlling the display device according to claim 1, wherein
update data for updating the software is acquired via the first communication terminal in response to the receiving of the update notification from the first communication terminal.

4. The method for controlling the display device according to claim 3, wherein
in a status where the communication with the first communication terminal is disconnected during acquisition of the update data and where communication with a second communication terminal is established after the disconnection of the communication, a part that cannot be acquired via the first communication terminal, of the update data, is acquired via the second communication terminal.

5. The method for controlling the display device according to claim 1, wherein
the communication with the first communication terminal is short-range wireless communication, and
the method further comprises:
providing a second instruction to the first communication terminal in response to the receiving of the update notification from the first communication terminal, the second instruction instructing the first communication terminal to acquire a data volume of update data for updating the software; and
deciding whether or not to acquire the update data using the short-range wireless communication, based on a data volume acquired by the first communication terminal in response to the second instruction, when receiving the data volume from the first communication terminal.

6. The method for controlling the display device according to claim 3, wherein
an image showing that the update data is being acquired is displayed on the display surface, while the update data is being acquired.

7. The method for controlling the display device according to claim 1, wherein
when information that is different from the update notification is received from the first communication terminal, an image based on the information is displayed on the display surface.

8. The method for controlling the display device according to claim 1, wherein
the communication with the first communication terminal is short-range wireless communication.

9. A display device storing software, the display device comprising:
a first instruction unit providing a first instruction to a first communication terminal in a status where communication with the first communication terminal is established, the first instruction instructing the first communication terminal to acquire an update notification prompting update of the software;
a display unit; and
a display control unit causing the display unit to display, on a display surface, an update notification image based on an update notification acquired by the first communication terminal in response to the first instruction, when receiving the update notification from the first communication terminal.

10. The display device according to claim 9, wherein
the first instruction unit provides the first instruction to the first communication terminal in response to the establishing of communication with the first communication terminal.

11. The display device according to claim 9, further comprising:
an update data acquisition unit acquiring update data for updating the software via the first communication terminal in response to the receiving of the update notification from the first communication terminal.

12. The display device according to claim 11, wherein
in a status where the communication with the first communication terminal is disconnected during acquisition of the update data and where communication with a second communication terminal is established after the disconnection of the communication, the update data acquisition unit acquires a part that cannot be acquired via the first communication terminal, of the update data, via the second communication terminal.

13. The display device according to claim 9, further comprising:
a second instruction unit providing a second instruction to the first communication terminal in response to the receiving of the update notification from the first communication terminal, the second instruction instructing the first communication terminal to acquire a data volume of update data for updating the software; and
a decision unit deciding a communication method used to acquire the update data, based on a data volume acquired by the first communication terminal in response to the second instruction, when receiving the data volume from the first communication terminal.

14. The display device according to claim 11, wherein
the display control unit causes the display unit to display, on the display surface, an image showing that the update data is being acquired, while the update data is being acquired.

15. The display device according to claim 9, wherein
when receiving information that is different from the update notification from the first communication terminal, the display control unit causes the display unit to display an image based on the information, on the display surface.

16. The display device according to claim 9, wherein
the communication with the first communication terminal is short-range wireless communication.

17. A display system comprising:
a display device storing software; and
a first communication terminal,
the display device comprising:
a first instruction unit providing a first instruction to the first communication terminal in a status where communication with the first communication terminal is established, the first instruction instructing the first communication terminal to acquire an update notification prompting update of the software;
a display unit; and
a display control unit causing the display unit to display, on a display surface, an update notification image based on an update notification acquired by the first communication terminal in response to the first instruction, when receiving the update notification from the first communication terminal,
the first communication terminal comprising:
an update notification acquisition unit acquiring the update notification from a server managing update of the software, when receiving the first instruction; and
a providing unit providing the update notification to the display device.
